(19) United States
(12) Patent Application Publication
(10) Pub. No.: US 2006/0201149 A1
(43) Pub. Date: Sep. 14, 2006

(54) Thin, flexible actuator array to produce complex shapes and force distributions

(75) Inventors: S. James Biggs, Cambridge, MA (US); R. Dodge Daverman, Boston, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Massachusetts Institute of Technology, Cambridge, MA (US)

(21) Appl. No.: 11/078,195

(22) Filed: Mar. 11, 2005

(51) Int. Cl. F01B 29/10; F02G 1/04

(52) U.S. Cl. 60/527

(57) ABSTRACT

An actuator includes a bistable mechanism having a tension beam and a compression beam defined by a relief slit in a flexible substrate; and a first shape memory element that upon heating actuates the actuator from a first position to a second position. A heat source can be thermally coupled to actuate the first shape memory element, or the first shape memory element can be heated by passing current through the element. The actuators can be formed in an array. Such arrays can be useful for tactile displays, massagers, and the like. Also included are methods of operation and manufacturing.

### GOVERNMENT SUPPORT

The invention was supported, in part, by grant N66001-02-C-8802 from the Defense Advanced Research Projects Agency (DARPA). The Government has certain rights in the invention.

### BACKGROUND OF THE INVENTION

Restoring mechanisms, also known as “overcenter mechanisms,” “snap springs,” “snap blades,” and the like, are components of many devices, including valves and electrical switches.

Monostable mechanisms are known. For example, a rigid support can be overlaid by a membrane with projections that restore push buttons, such as those of a telephone keypad, back to an undepressed position. However, such designs lack a second stable position as in a bistable mechanism.

Discontinuous cantilever bistable mechanisms are known, wherein discontinuous cantilevered tongues are held in relation to each other by a surround fashioned from the same sheet as the cantilevers. These discontinuous cantilevers can impart bistable movement to a notched rod captured between the tips of the cantilevers. Discontinuous cantilevers can be undesirable, however, for applications needing a smooth surface on the bistable mechanism.

Dome-like bistable mechanisms, including linear and planar arrays thereof, have been fabricated of thin sheet metal. However, common materials typically limit the height of the dome to about 10% of its diameter, and consequently the maximum throw can be limited to about twice the dome height (hence, about 20% of a diameter).

Disk-like bistable mechanisms are known where a disk is buckled by insertion into a circular housing slightly smaller than the disk. Alternately, or in conjunction, disk mechanisms can be buckled by introduction of a part, such as a rod, that radially displaces portions of the mechanism. These designs can require assembly and one or more additional parts for proper function, and can have limitations similar to dome-like mechanisms.

A micromechanical continuous buckled beam mechanism includes a bistable bridge spanning a recess in an underlying support material. Such a design includes at least two parts (the bridge and the rigid support which must be assembled). Moreover, the rigid support can be unsuitable for applications requiring flexibility and/or for macroscopic applications where the added weight of the rigid support is undesirable.

Piezoelectric actuators are known, but can be expensive and bulky, and can require complicated control electronics. Shape memory alloy actuators are known, but can involve significant amounts of heat generation and can have high power requirements, and can be limited in frequency. For example, maintaining a stable position with existing shape memory actuators can require continuous input of power, which can be undesirable for portable applications and can generate undesirable amounts of heat. Moreover, the operation frequency of shape memory actuators can be limited by heat dissipation because the alloy needs to cool below its activation temperature before the actuator can be operated again.

### SUMMARY OF THE INVENTION

There is therefore a need in the art for improved bistable mechanisms suitable for actuators, arrays of such actuators, means of operating or controlling actuators, and methods of manufacturing actuators.

An actuator includes a bistable mechanism having a tension beam and a compression beam defined by a relief slit in a flexible substrate; and a first shape memory element that upon heating actuates the bistable mechanism from a first position to a second position. In various embodiments, the tension beam and the compression beam can be substantially parallel. The tension beam can include a permanent out-of-plane deformation. The actuator can include a second tension beam defined by a second relief slit. The first shape memory element can include a shape memory alloy, a bimetallic strip, or a thermally-actuated shape memory polymer. The actuator can include a second shape memory element that actuates the bistable mechanism from the second position to the first position. A heat source can be thermally coupled to each shape memory element that independently heats the shape memory elements to actuate the bistable mechanism. Or, the actuator can include electrical leads coupled to each shape memory element that independently heat the shape memory elements to actuate the bistable mechanism. The first shape memory element can include at least two substantially parallel shape memory alloy wires electrically coupled in series to the electrical leads. The shape memory elements can be mechanically coupled to opposite sides of the compression beam to convert the displacement of each shape memory element into a greater displacement at the compression beam. The flexible substrate can include a material selected from the group consisting of steel alloy, phosphor bronze alloy, aluminum alloy, titanium alloy, carbon fiber/epoxy composite, fiberglass/epoxy composite, Kevlar/epoxy composite, polyimide, polyamide, polyester, polyvinylidene fluoride (PVDF), polypropylene, polyethylene, and urethane. The shape memory element can be in the form of a laminated array of shape memory wires mechanically coupled to the bistable mechanism. A first heat source can be thermally coupled to the first shape memory element. A second heat source can be thermally coupled to the second shape memory element. The shape memory wires can be substantially physically parallel shape memory alloy wires. The wires can include a shape memory alloy selected from the group consisting of NiTi, CuZnAl, and CuAlNi. Preferably, the wires are NiTi. The shape memory wires can have a diameter of less than about 500 micrometers. The ratio of the diameter of the wires divided by the distance between adjacent wires can be less than about 1. The actuator operates in air at 25° C. at a frequency of at least about 2 cycles per second. The actuator can be adapted for automatic control. For example, the shape memory element can be coupled to an open loop automated controller.

In some embodiments, an actuator includes a bistable mechanism and a first shape memory element mechanically coupled to the bistable mechanism that upon heating exerts a force that actuates the bistable mechanism from a first position to a second position; in such embodiments, the first shape memory element includes a laminated array of shape memory wires. In various embodiments, a first heat source can be thermally coupled to the first shape memory element, or electrical leads can be coupled to the first shape memory element, whereby the first shape memory element is heated by application of electrical current. The first shape memory element can include at least two substantially parallel shape memory alloy wires electrically coupled in series to the electrical leads. A second heat source can be thermally coupled to a second shape memory element at the bistable mechanism that heats the second shape memory element to exert a force that actuates the bistable mechanism from the second position to the first position. The shape memory wires can be substantially physically parallel shape memory alloy wires. The wires can include a shape memory alloy selected from the group consisting of NiTi, CuZnAl, and CuAlNi, in some embodiments NiTi. The shape memory wires can have a diameter of less than about 500 micrometers. The ratio of the diameter of the wires divided by the distance between adjacent wires can be less than about 1. The actuator can operate in air at 25° C. at a frequency of at least about 2 cycles per second. The bistable mechanism can include a tension beam and a compression beam defined by a relief slit in a flexible substrate, and the first shape memory element can actuate the compression beam from the first position to the second position. The tension beam can include a permanent out-of-plane deformation. Each shape memory element can be coupled to the compression beam to convert the displacement of each shape memory element into a greater displacement at the compression beam. A second tension beam defined by a second relief slit can be included, wherein the beams and the slits can be substantially parallel. The actuator adapted for automatic control, e.g., by coupling to an open loop automated controller. The flexible substrate can include a material selected from the group consisting of steel alloy, phosphor bronze alloy, aluminum alloy, titanium alloy, carbon fiber/epoxy composite, fiberglass/epoxy composite, Kevlar/epoxy composite, polyimide, polyamide, polyester, polyvinylidene fluoride, polypropylene, polyethylene, and urethane.

An actuator array includes two or more of any of the above actuators in the flexible substrate. The flexible substrate can be in the form of a tape including the array of actuators as a linear array; or, the flexible substrate can be in the form of a sheet including the array of actuators as a two-dimensional array. The array can include one or more multiplexing diodes to independently control each actuator. The array can include an open loop automated controller coupled to the actuators.

A method of operating the actuator includes automatically controlling the actuator by heating the first shape memory element to exert a force that actuates the bistable mechanism from a first position to a second position. A second heat source can be heated to actuate a second shape memory element to exert a force that actuates the bistable mechanism from the second position to the first position. In various embodiments, the shape memory elements can be at ambient temperature while the bistable mechanism maintains the first position or the second position, e.g., the heat sources can be deactivated after actuating the actuator.

A method of operating the actuator array includes automatically, independently controlling each actuator.

A method of manufacturing a shape memory element includes wrapping a shape memory wire and an adhesive substrate on a spool to create a layer of substantially physically parallel wire loops adhered to the adhesive layer, and separating a discrete shape memory wire element, the element including an array of substantially physically parallel shape memory wire segments adhered to a discrete portion of the adhesive substrate. The adhesive substrate can include a pattern that defines each discrete shape memory element. The method can include separating each discrete shape memory wire element by mechanical cutting, or by laser cutting. The method can include wrapping the adhesive substrate on the spool and wrapping the wire on the adhesive substrate to contact the wire to the adhesive layer; or, the method can include wrapping the wire on the spool, and wrapping the adhesive substrate on the wire to contact the adhesive layer to the wire. The method can include curing the adhesive layer of the adhesive substrate to create a laminated shape memory element. The wire segments of each discrete shape memory wire element can be cured in a curable matrix to create the laminated shape memory element. The method can include stenciling a conducting adhesive between at least two of the wire segments, whereby the wire segments are conductively linked.

The disclosed inventions have numerous advantages over the prior art. For example, the method of manufacturing the shape memory elements from wire is less expensive than other methods such as sputtering and etching, and creates fewer environmental hazards. Mechanically cutting the wires allows the elements to function without re-annealing, which also allows the use of substrates such as non-polyamide polymers, with melting temperatures below the annealing temperature of shape memory alloys.

Moreover, the separate wires can have more surface area which can allow better contact with laminating adhesive to avoid wire pull-out, and can dissipate heat more rapidly compared to larger pieces of shape memory alloy. High surface area per unit volume can allow a higher actuation frequency.

Also, the shape memory elements in the disclosed inventions are discrete. Compared to devices wherein adjacent actuators are formed from a continuous piece of shape memory alloy, the disclosed inventions can be more isolated and thus can experience less thermal cross talk.

Moreover, coupling two shape memory elements with a bistable mechanism allows the actuator to maintain a position while shut off after actuation, which can minimize power consumption and heat production compared to existing devices. This can be particularly beneficial for devices intended to operate in power or temperature sensitive environments, such as handheld massagers, massage chairs, massaging foot spas, massaging car seat covers, and similar products intended to operate near the human body.

Also, the elastic energy stored in the bistable mechanism can provide a restoring force to return a shape memory element to its original length after contraction.

Further, the bistable mechanism can transform the short (4%) contraction typical of shape memory alloys into a displacement large enough to be useful, when shape memory elements are coupled to the compression beam of the bistable mechanism; or can transform the contraction into a shorter but more forceful motion when the shape memory elements are coupled to the tension beam.

Another benefit of the bistable mechanism is that it enables simple, robust, open-loop control, whereas other devices can require complex closed-loop control because the resistance and Young's modulus of shape memory alloys change nonlinearly with heating, and the work cycle has hysteresis.

Yet another benefit of the bistable mechanism is that mechanisms of different orientations, size, mechanical characteristics, spacing, and the like can be combined in the same array of actuators.

### BRIEF DESCRIPTION OF THE DRAWINGS

FIGS. 1A, B and C are drawings showing A) a flexible substrate 102; B) a relief slit 104 formed in flexible substrate 102 and C) an exploded view of an actuator 100 wherein relief slit 104 defines a tension beam 106 and a compression beam 108, and the compression beam can be deformed to a first stable position. Also included in C) is a shape memory element 110.

FIGS. 1D, E and F are a sequence of drawings showing D) with actuator 100 in a first position, beginning actuation of shape memory element 110; E) a representation of actuator 100 between the first position and a second position; F) actuator 100 in the second position.

FIG. 1G depicts shape memory element 110′ that includes a set of at least two substantially physically parallel shape memory alloy wires 12′.

FIG. 1H depicts shape memory element 110′ wherein wires 12′ can be coupled electrically in parallel with respect to the current that can be employed for resistive heating via conducting links 14′.

FIG. 1I depicts an embodiment of a shape memory element 110″ where two wires 12″a and 12″b can be electrically coupled in series via conducting link 14″, which can increase the electrical resistance of shape memory element 110″ to facilitate such resistive heating.

FIG. 1J depicts an embodiment of a shape memory element 110′″ wherein at least two groups 10′″ (e.g., four) of two or more (e.g., three) parallel shape memory alloy (e.g., Nitinol) wires 12′″, wherein adjacent groups 10′″ can be electrically coupled via coupling links 14′″a-14′″e.

FIG. 1K depicts an intermediate step in some embodiments of manufacturing the shape memory element 110′″ shown in FIG. 1J.

FIG. 2 is a drawing showing an exploded view of actuator 200, wherein the tension beam 106 can have a permanent out of plane deformation 212.

FIG. 3 is a drawing showing an exploded view of actuator 300 that includes a second relief slit 314 which defines a second tension beam 316 from compression beam 108.

FIG. 4 is a drawing of a bistable mechanism 400 that includes a permanent out of plane deformation 422 in compression beam 408.

FIG. 5A is a drawing showing an exploded view of an actuator 500, which includes a bistable mechanism 501, a first shape memory element 510 mechanically coupled to the bistable mechanism, and a first heat source 524 thermally coupled to the first shape memory element that heats first shape memory element 510 to exert a force that actuates bistable mechanism 501 from a first position to a second position in the direction of the arrow.

FIG. 5B is a drawing showing an exploded view of actuator 500 further including bistable mechanism 501 equipped to be actuated by first shape memory element 510 and also includes a second shape memory element 511 that actuates the bistable mechanism from the second position to the first position in a direction opposite the arrow.

FIG. 6A is a drawing in perspective of a linear array 600 having three bistable mechanisms 634, 636, and 638 fabricated in a strip of flexible substrate 602.

FIG. 6B shows linear array 600′ as a schematic of array 600, where double ended arrows 634′, 636′, and 638′ symbolize the three elements 634, 636, and 638.

FIG. 6C is a general schematic 670 of a typical multiplexing arrangement, where for example, Nˆ2 (N=4 in this example) elements are addressed by 2N lines 672-679.

FIG. 7 is a schematic of a two dimensional array 700 having 9 elements.

FIG. 8 is a schematic of a two dimensional array 800 where the individual elements, e.g., bistable mechanisms or actuators, can have different orientations with respect to each other, different force characteristics due to different sizes, and are spaced in an irregular array.

FIG. 9 is a drawing of a method of manufacturing a shape memory element.

FIGS. 10A and 10B show steps that can be included in embedding shape memory elements 950 in a curable adhesive matrix 962.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. A description of preferred embodiments of the invention follows.

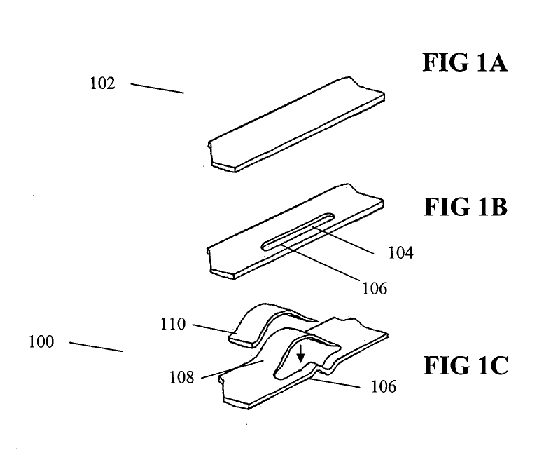

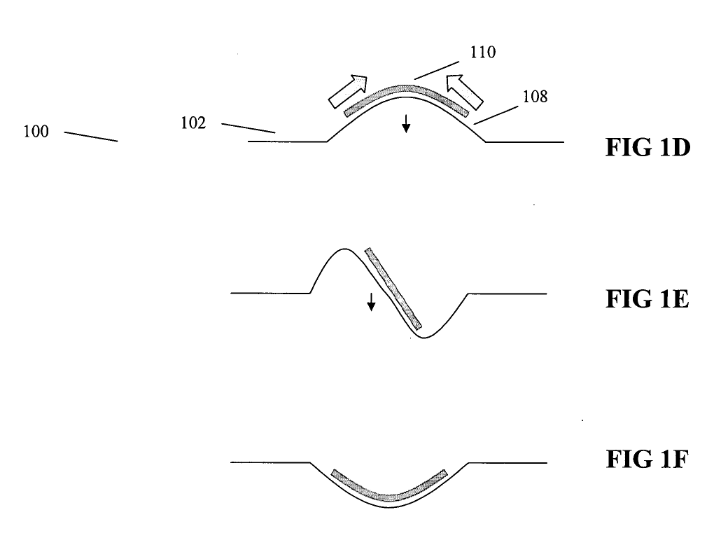

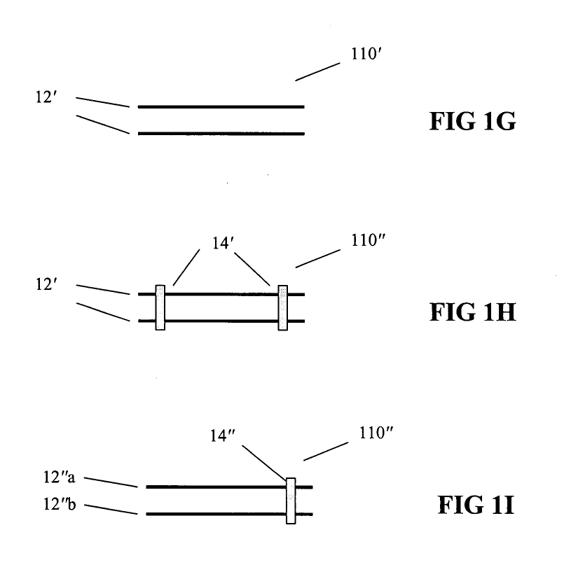

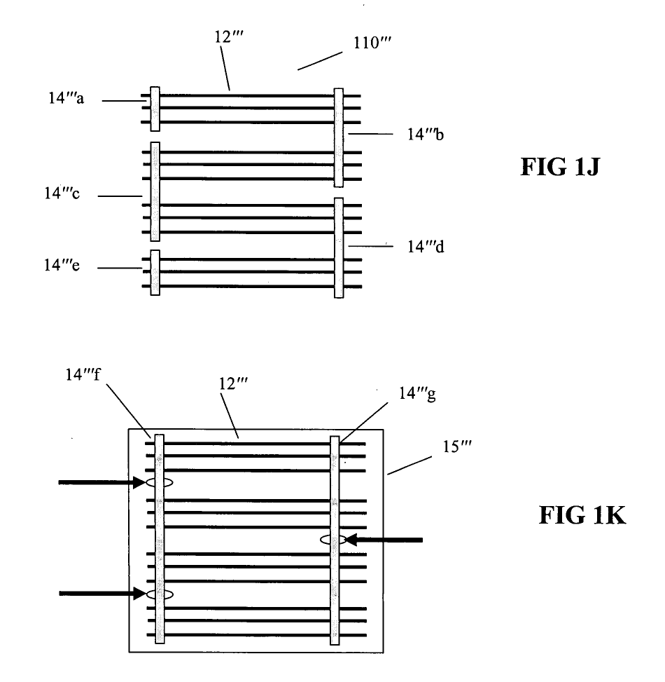

FIGS. 1A, 1B, 1C and 1C are drawings showing (FIG. 1A) a flexible substrate 102; (FIG. 1B) a relief slit 104 formed in flexible substrate 102 and (FIG. 1C) an exploded view of an actuator 100 wherein relief slit 104 defines a tension beam 106 and a compression beam 108, and the compression beam can be deformed to a first stable position. Also included in FIG. 1C) is a shape memory element 110. Tension beam 106 and compression beam 108 can be formed to be substantially parallel, e.g., parallel in the plane of flexible substrate 102. Compression beam 108 can be formed into a first position as shown in mechanism 100. For example, a stable deformation of compression beam 108 out of the plane of flexible substrate 102 can be made. A sufficient force having a component in the direction of the arrow can actuate compression beam 106 from the first position in 100 to a second position, e.g., a complementary out of plane deformation on the opposite side of flexible substrate 102 in the direction shown by the arrow.

FIGS. 1D, E and F are a sequence of drawings showing D) with actuator 100 in a first position, beginning actuation of shape memory element 110; E) a representation of actuator 100 between the first position and a second position; F) actuator 100 in the second position. In these views, relief slit 104 is not seen and tension beam 106 is omitted for clarity. In FIG. 1D, compression beam 108 starts at a first stable position. Actuation begins when shape memory element 110 is activated and shortens in the direction shown by the pair of large arrows. This stresses compression beam 108, causing it to move through the plane of substrate 102 as shown in FIG. 1E, until actuator 100 comes to rest at a second stable position in FIG. 1F. An actuator such as 100, with only a single shape memory element, can be useful for applications where an external force can operate the actuator from the second position to the first position, e.g., by a human operator pushing the actuator from the second position to the first position.

Flexible substrate 102 can include a material selected from the group consisting of steel alloy, phosphor bronze alloy, aluminum alloy, titanium alloy, carbon fiber/epoxy composite, fiberglass/epoxy composite, Kevlar/epoxy composite, polyimide, polyamide, polyester, polyvinylidene fluoride (PVDF), polypropylene, polyethylene, polyurethane, and the like.

Bistable actuator 100 includes a separate shape memory element 110, which can be made of a shape memory alloy, a bimetallic strip, thermally-actuated shape memory polymers (such as styrene-based thermally-actuated shape memory polymers and oligo(e-caprolactone) dimethacrylate+n-butyl acrylate thermally-actuated shape memory polymers), or the like.

Typically, shape memory element 110, can be made of a shape memory alloy. As used herein, shape memory alloy can include any such alloy know to the art, for example, NiTi, CuZnAl, CuAlNi, and the like. More preferably, shape memory element 110 is NiTi.

As used herein, a bimetallic strip can be any combination of two metals that expand differently in response to increasing temperature. Such strips are well-known to the art, for example, bimetallic strips employed in thermostats, and the like. Shape memory element 110 can be a bimetallic strip separate from flexible substrate 102. Or, flexible substrate 102 can function as one metal of the bimetallic strip. In embodiments wherein two shape memory elements, as bimetallic strips, are employed on opposing sides of the bistable mechanism, flexible substrate 102 can function as one metal of each bimetallic strip.

Shape memory element 110 can be actuated by heating, e.g., by resistive heating through a current passed through the element, by application of a voltage, by thermal contact with a separate heating element, by radiative or convective heat transfer from an external heat source, or the like. Typically, shape memory element 110 is actuated by heating with a resistive heating element that is in thermal contact with the shape memory element.

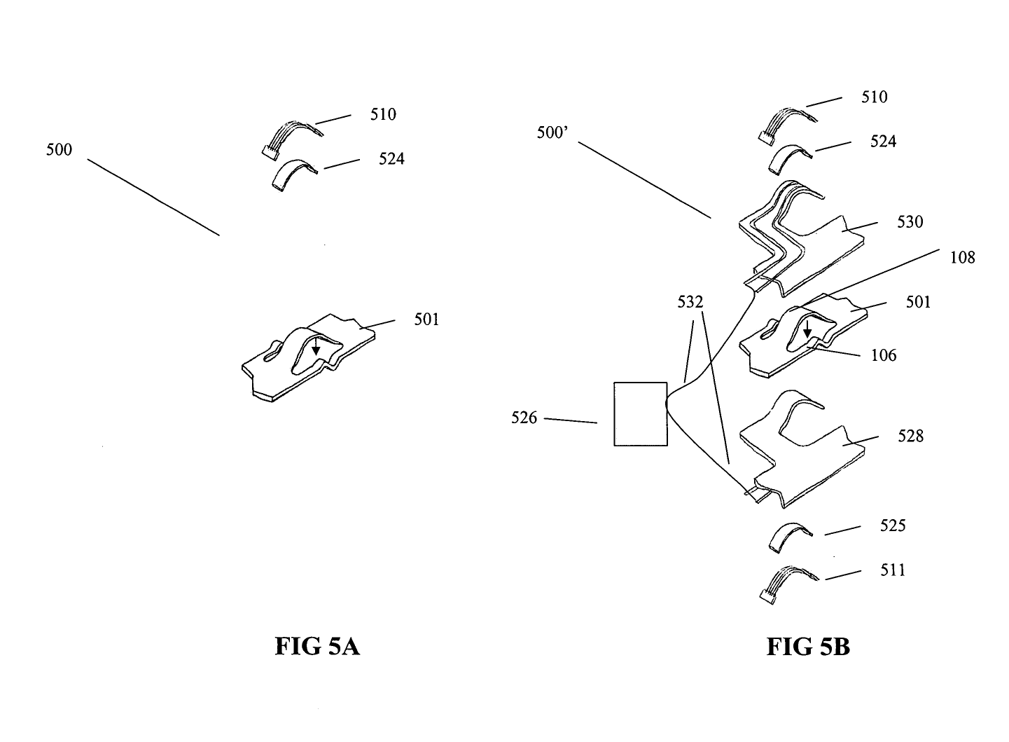

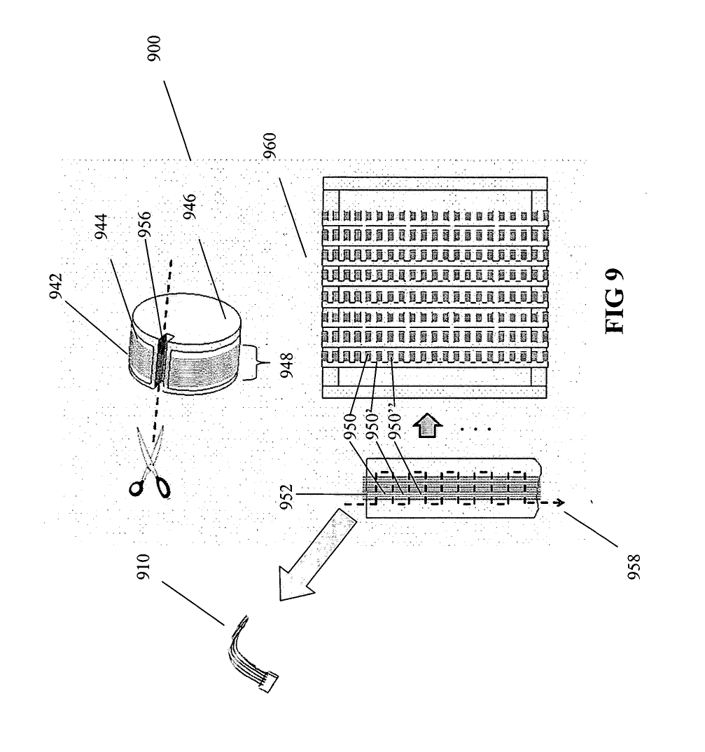

Shape memory element 110 can be in the form of a strip or sheet, or more preferably is in the form of a set of substantially physically parallel shape memory alloy wires, typically in a laminated array; see also features 510/511 in FIG. 5A and 5B and feature 910 in FIG. 9. The wires can have a diameter of less than about 500 micrometers. The ratio of the diameter of the wires divided by the distance between adjacent wires can be less than about 1.

In various embodiments, the shape memory element can be actuated by resistive heating through a current passed through the element, wherein typically, the element is in the form of a set of at least two substantially physically parallel shape memory alloy wires 12′ as shown in shape memory element 110′ in FIG. 1G. 1n some embodiments, wires 12′ can be coupled electrically in parallel with respect to the current that can be employed for resistive heating, e.g., via conducting links 14′ as shown in FIG. 1H. Conducting links 14′ can be a metallic conductor (e.g., a copper element that contacts each wire, metallic solder melted to each wire, and the like) or typically, a conductive epoxy or adhesive such as silver doped silicone adhesive, and the like.

FIG. 1I depicts an embodiment of a shape memory element 110″ where two wires 12″a and 12″b can be electrically coupled in series via conducting link 14″, which can increase the electrical resistance of shape memory element 110″ to facilitate such resistive heating. For example, the current can be passed into one wire 12″a, through conducting link 14″, and back through wire 12″b.

FIG. 1J depicts an embodiment of a shape memory element 110′″ wherein at least two groups 10′″ (e.g., four) of two or more (e.g., three) parallel shape memory alloy (e.g., Nitinol) wires 12′″, wherein adjacent groups 10′″ can be electrically coupled via coupling links 14′″a-14′″e. For example, current can be passed into shape memory element 110′″ at coupling links 14′″a and pass in sequence through coupling links 14′″b, 14′″c, 14′″d, and 14′″e.

FIG. 1K depicts an intermediate step in some embodiments of manufacturing the shape memory element 110′″ shown in FIG. 1J. The wires 12′″ can be contacted to a substrate, e.g., adhesive substrate 15′″ which can have holes at the positions indicated by the arrows. Coupling link material, e.g., a silver doped silicone adhesive can be stenciled in two sections 14′″f and 14′″g. After stenciling the silver conducting adhesive, adhesive substrate 15′″ which has wires 12′″ and stenciled silver doped silicone adhesive sections 14′″f and 14′″g on it, and the holes in adhesive substrate 15′″ allow the excess silver doped silicone adhesive to fall through creating coupling links 14′″a-14′″e shown in FIG. 1J.

The frequency of operation of shape memory devices such as shape memory element 110 can be determined in part by the ability of the device to dissipate heat. For example, shape memory element 110 must be below its critical temperature before it can be actuated again. Thus, when shape memory element 110 is in the form a set of substantially physically parallel shape memory alloy wires, the extra surface area of the wires and the distance between adjacent wires can allow it to dissipate heat more rapidly than if shape memory element 110 was the same mass of shape memory alloy in a monolithic form such as a strip or sheet. Thus, in preferred embodiments, shape memory element 110 can be actuated at a frequency at 25° C. in air of at least about 2 cycles per second.

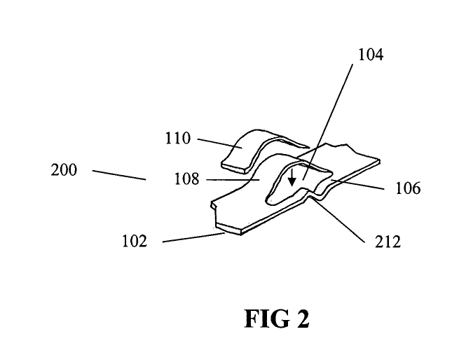

FIG. 2 is a drawing showing an exploded view of an actuator 200, wherein the tension beam 106 can have a permanent out of plane deformation 212. Deformation 212 can introduce greater tension into tension beam 106, which can lead to greater compression in compression beam 108. This can lead to a greater force required to actuate mechanism 200 (compared to mechanism 100), and/or to a greater force applied by mechanism 200 (compared to mechanism 100) as the mechanism moves from a first position to a second position in the direction of the arrow.

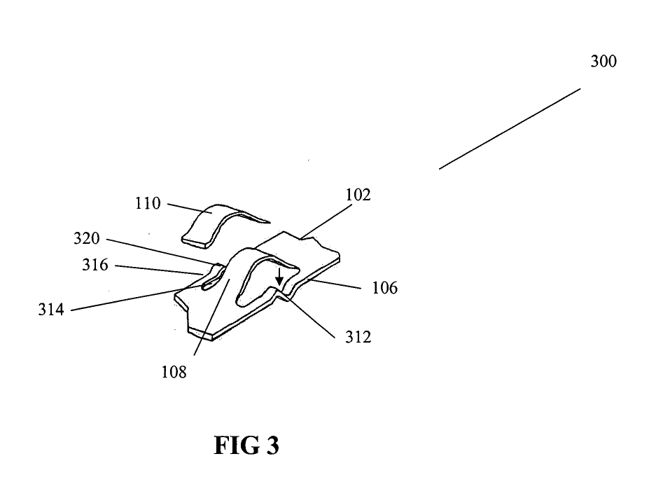

FIG. 3 is a drawing showing an exploded view of an actuator 300 that includes a second relief slit 314 which defines a second tension beam 316 from compression beam 108. Tension beam 316 and compression beam 108 can be formed to be substantially parallel, e.g., parallel in the plane of flexible substrate 102. Tension beam 316 can have a permanent out of plane deformation 320.

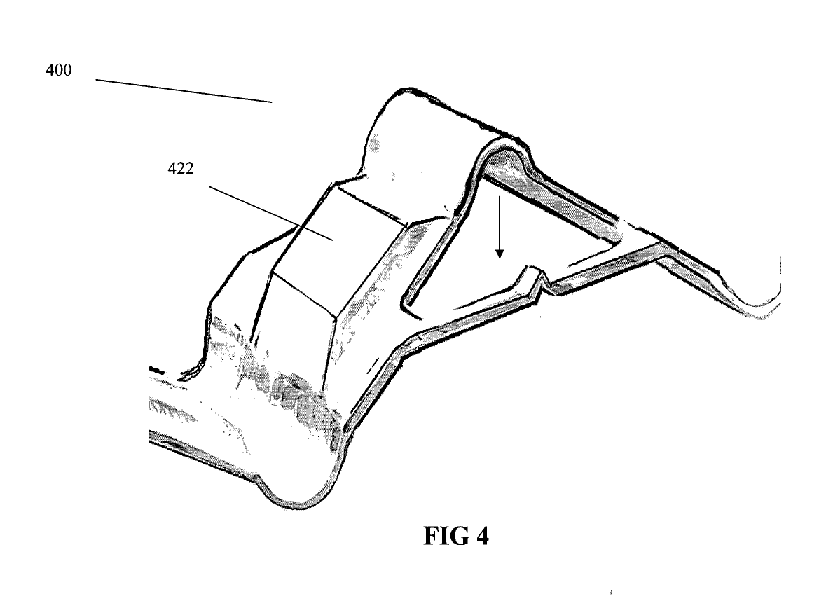

FIG. 4 is a drawing of a bistable mechanism 400 that includes a permanent out of plane deformation 422 in compression beam 408. For clarity, shape memory element (such as 110) is not shown. Deformation 422 can stiffen mechanism 400, which can lead to a greater force required to actuate mechanism 400 (compared to mechanism 100), and/or to a greater force applied by mechanism 400 (compared to mechanism 100) as the mechanism moves from its first position to its second position in the direction of the arrow. Deformation can also produce a relatively inflexible landing suitable for surface mount electronics or other components.

FIG. 5A is a drawing showing an exploded view of an actuator 500, which includes a bistable mechanism 501, a first shape memory element 510 mechanically coupled to the bistable mechanism, and a first heat source 524 thermally coupled to the first shape memory element that heats first shape memory element 510 to exert a force that actuates bistable mechanism 501 from a first position to a second position in the direction of the arrow. In embodiments of the actuator, shape memory element 510 can be any of the elements described above for the bistable mechanism in FIG. 1. Typically, in embodiments of the actuator, shape memory element 510 is a laminated array of shape memory wires as depicted.

FIG. 5B is a drawing showing an exploded view of actuator 500 further including bistable mechanism 501 equipped to be actuated by first shape memory element 510 and also including a second shape memory element 511 that actuates the bistable mechanism from the second position to the first position in a direction opposite the arrow. First and second heat sources 524 and 525 (e.g., resistive heating elements) can be thermally coupled to their corresponding shape memory element.

Shape memory elements 510 and 511 can be mechanically coupled to opposite sides of compression beam 108 to convert the displacement of each shape memory element into a greater displacement at the compression beam.

The actuator can be adapted for automatic control. For example, the shape memory element can be coupled to an open loop automated controller 526. Dielectric layers 528 and 530 can be included that can separate heat sources 524 and 525 from flexible substrate 102, e.g., when flexible substrate 102 is a conductor. Electrical leads 532 can be included to power heat sources 524 and 525. Leads 532 can be coupled to. automated controller 526.

Actuator 500 can be automatically controlled by operating controller 526 (e.g., an open loop automated controller) to heat first shape memory element 510 via heat source 524 to exert a force that actuates the bistable mechanism from a first position to a second position. The second shape memory element can be heated via heat source 525 to exert a force that actuates the bistable mechanism from the second position to the first position. Heat sources 524 and 525 can be deactivated after actuating the mechanism between the first and second positions after actuation, e.g., the shape memory elements can be at ambient temperature while the bistable mechanism maintains the first position or the second position. Controller 526 can be employed to control the displacement of shape memory elements 510 or 511 to give a greater displacement at compression beam 108, wherein shape memory elements 510 or 511 are mechanically coupled to compression beam 108. Controller 526 can be employed to operate the actuator at a frequency at 25° C. in air of at least about 2 cycles per second.

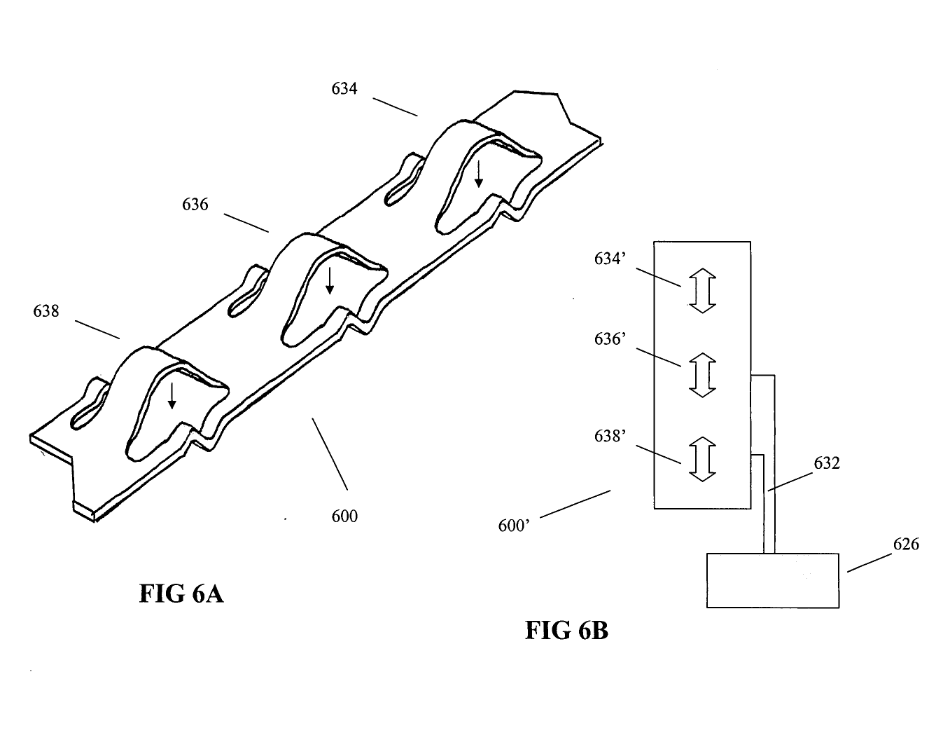

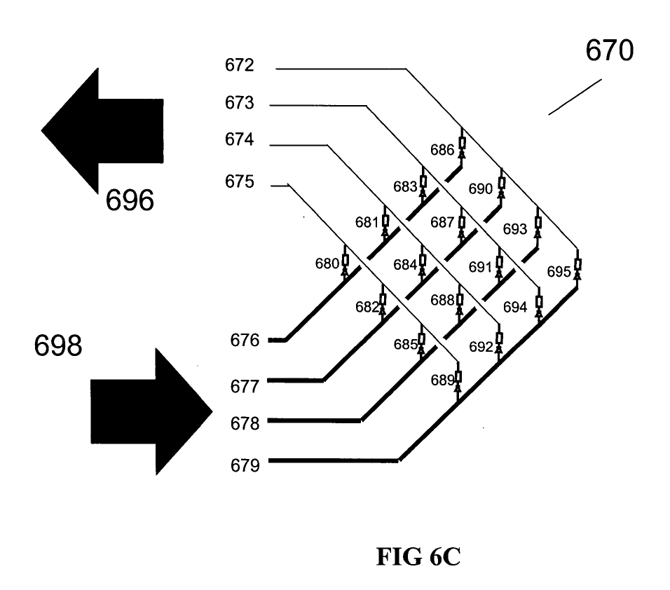

FIG. 6A is a drawing in perspective of a linear array 600 having 3 bistable mechanisms 634, 636, and 638 fabricated in a strip of flexible substrate 602. For clarity, shape memory elements such as 110 are not shown. Each of the mechanisms in array 600 can be actuated independently. Two or more mechanism can be actuated to give a net force or net motion to array 600. For example, actuating the three mechanisms as in FIG. 6A can impart a force in the direction of the arrows shown.

FIG. 6B shows linear array 600′ as a schematic of array 600, where double ended arrows 634′, 636′, and 638′ symbolize the three elements 634, 636, and 638. As used herein, such double ended arrows can symbolize any actuator disclosed herein. Such arrays can be coupled by electrical leads 632 to controller 626. In preferred embodiments, the array can comprise a plurality of multiplexing diodes, whereby electrical leads can be shared among actuators, thus reducing the number of electrical leads compared to the number needed to address each actuator separately.

FIG. 6C is a general schematic 670 of a typical multiplexing arrangement, where for example, Nˆ2 (N=4 in this example) elements are addressed by 2N lines 672-679. N lines 672-675 can be employed for sourcing current and the other N lines 676-679 can be employed for sinking current. The shape memory element can be referred to by the intersection of the source and sink lines, for example, element 672/676, element 772/677, and the like. To trigger a single element (e.g., shape memory element 672/676), its source line can be activated (e.g., 672), and its sink line (e.g., 676) can be activated. Current can flow from 672 through desired shape memory element 672/676 to 676. The diodes associated with the elements (diodes 680-695, in this case diode 686) can prevent unintended current flow through neighboring resistors. The elements of the array can then be controlled by controller 626 as for actuator 501 in the description of FIG. 5B above.

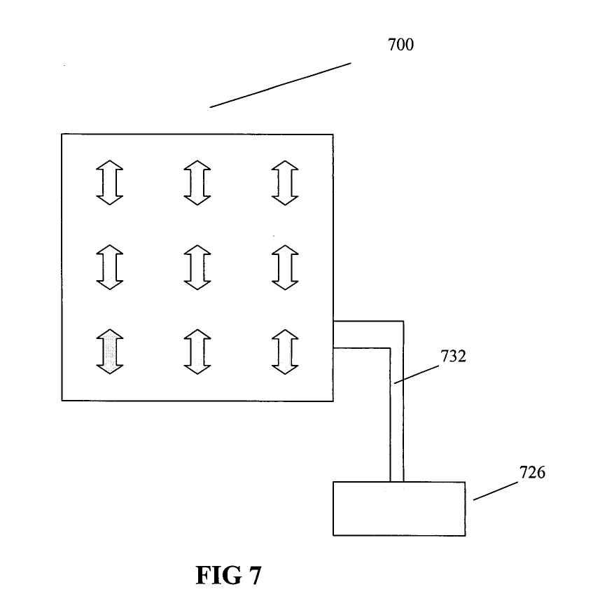

FIG. 7 is a schematic of a two dimensional array 700 having 9 elements. As above, the elements can be any bistable mechanism or any actuator disclosed herein. Such arrays can be coupled by electrical leads 732 to controller 726, for example through one or more multiplexing diodes, e.g., diode 740. The elements can be addressed for independently controlled actuation by automated controller 726.

When bistable mechanisms or actuators are elements in an array, the elements can be the same or different in size, construction, mechanical characteristics, orientation, spacing, and the like. For example, in typical embodiments, such array elements are the same size, have the same mechanical characteristics, are oriented in the same direction, are regularly spaced on the array, as depicted in arrays 600 and 700 in FIGS. 6A and 7.

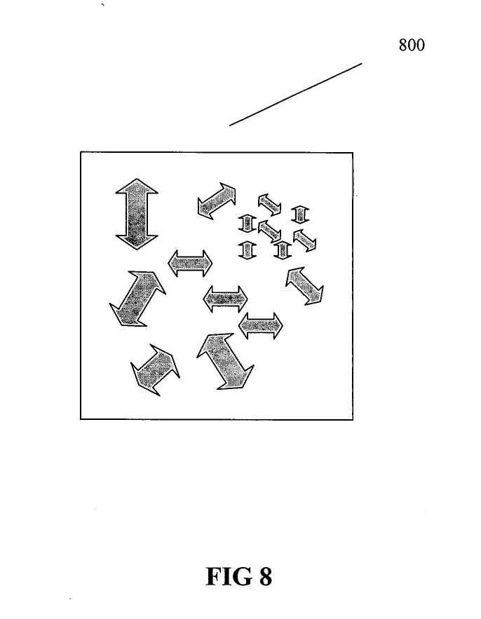

FIG. 8 is a schematic of a two dimensional array 800 where the individual elements, e.g., bistable mechanisms or actuators, can have different orientations with respect to each other, different force characteristics due to different sizes, and are spaced on an irregular array. These respective differences can be symbolized schematically in FIG. 8 by the orientation, size, and spacing of the double arrows.

FIG. 9 is a drawing of a method of manufacturing a shape memory element. A shape memory wire 942 and an adhesive substrate 944 (e.g., a substrate with a temporary or permanently curable adhesive layer, typically temporary, such as adhesive tape) can be wrapped on a spool 946 to create a layer of substantially physically parallel wire loops 948 adhered to adhesive substrate 944. The method can include wrapping adhesive substrate 944 on spool 946 and wrapping wire 942 on adhesive substrate 944 to contact wire 942 to the adhesive layer of adhesive substrate 944. Or, wire 942 can be wrapped on spool 946, and adhesive substrate 944 can be wrapped on wire 942 to contact the adhesive layer of adhesive substrate 944 to wire 942.

The wire can be wrapped on the spool at a desired pitch or loop spacing using, e.g., micro-controlled rotary and linear stages. The pitch or loop spacing can be set so that the ratio of the diameter of the wires divided by the distance between adjacent wire loops on the spool is less than about 1. The wires can include a shape memory alloy selected and sized as described above under FIG. 1. The tension on the wire can be set to prestrain the wires to a desired amount to facilitate the shape memory effect. For example, for NiTi wires, a prestrain of between about 0% and about 8% can be employed.

The combination of spooled wire 942 on adhesive substrate 944 can be removed from the spool 946 by cutting via a keyway 956 in the spool.

The method can include separating discrete shape memory wire elements 950, 950′, 950″ . . . by mechanical or laser cutting, preferably mechanical cutting. Discrete shape memory wire elements 950, 950′, 950″ . . . each include an array of substantially physically parallel shape memory wire segments 952 adhered to the adhesive substrate

The adhesive layer of adhesive substrate 944 can be cured to create laminated shape memory element 910. Or, wire segments 952 of each discrete shape memory wire element 950 can be cured in a separately applied curable matrix (e.g., a polymer curable by exposure to radiation (light, heat, ultraviolet light, electron beam radiation) curing agents, catalysts, and the like) to create laminated shape memory element 910. For example, the wire element 950 can be aligned in a jig, at least a portion of the wire segments 952 can be embedded in a uncured adhesive matrix, which can be applied with a stencil; the adhesive can be cured; and the laminated shape memory element 910 can be released, optionally with solvent.

In another embodiment, adhesive substrate 944 can include a pattern that defines each discrete shape memory element, e.g., a pre-printed or pre-cut pattern that facilitates separating discrete shape memory wire elements 950, 950′, 950″ . . . . For example, the pattern can be an interdigitating pattern that can lead to less waste, as shown by dotted line 958. The pattern can preferably be laser cut. Moreover, the interdigitating pattern is cut, two interdigitating strips of adhesive substrate comprising discrete shape memory wire elements 950, 950′, 950″ are released. These interdigitating strips can be mounted on an alignment frame 960 which can facilitate alignment of the elements for application of the curable adhesive matrix to each element. After curing, individual laminated shape memory elements 910 can be separated and released. Or, alignment frame 960 can hold the discrete shape memory wire elements 950, 950′, 950″ and the uncured matrix in a position to contact an array of bistable mechanisms (e.g., arrays 600 and 700 in FIGS. 6A and 7). Upon contacting the array, the curable matrix can be cured and the adhesive substrate removed, leaving individual laminated shape memory elements 910 adhered to the bistable elements of the array.

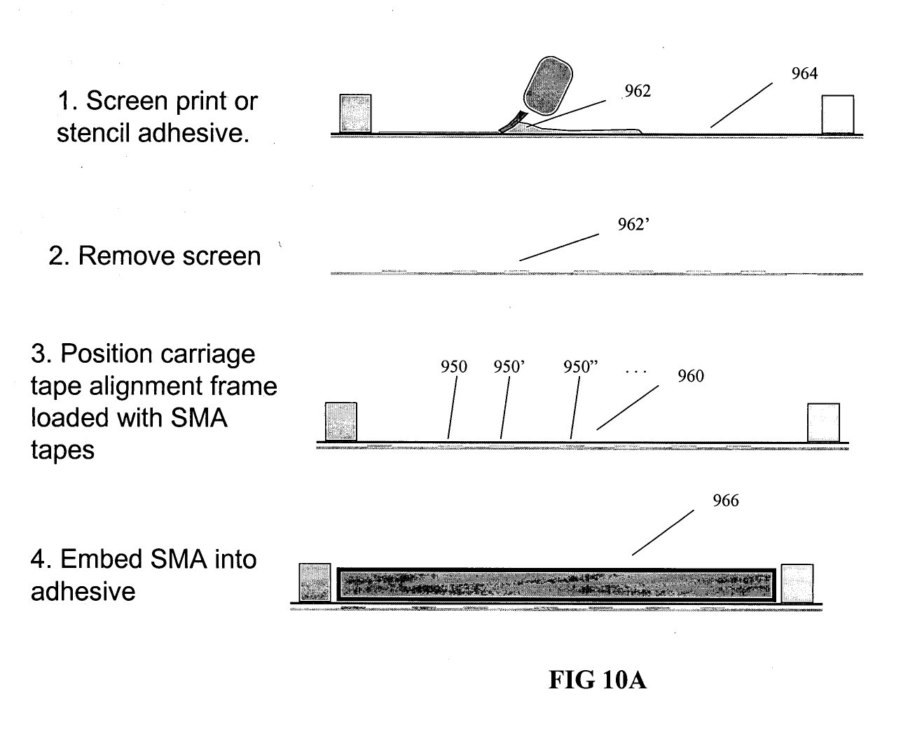

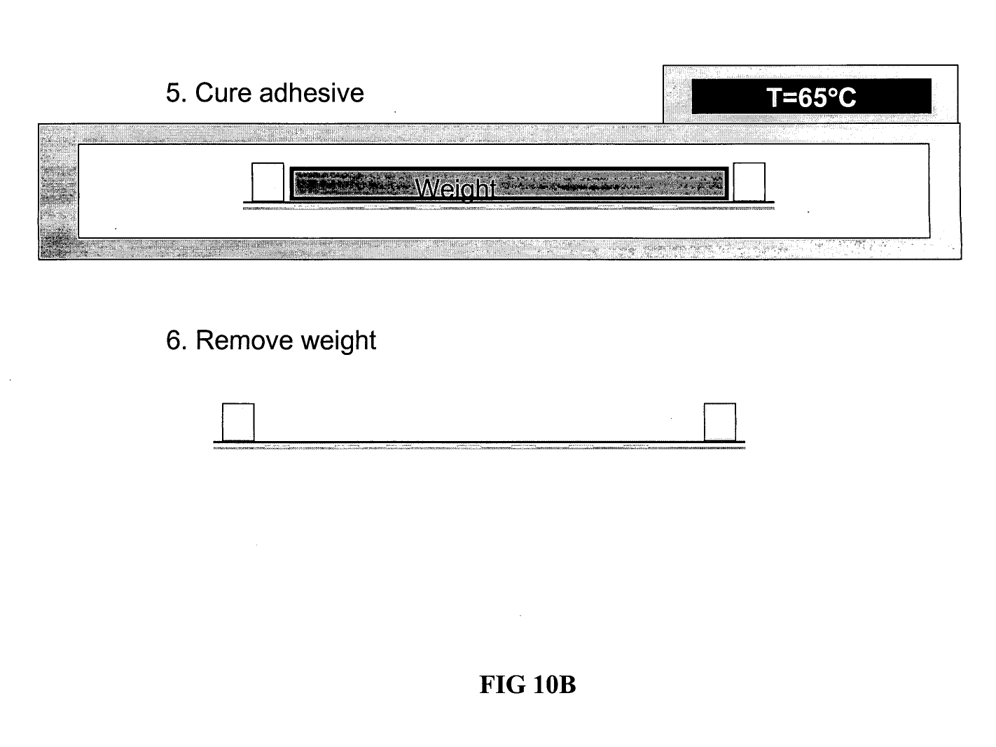

FIGS. 10A and 10B show steps that can be included in embedding shape memory elements 950 in a curable adhesive matrix 962. In step 1, curable adhesive matrix 962 can be screen printed, stenciled, or otherwise patterned using screen/stencil 964. In step 2, screen/stencil 964 can be removed. In step 3, the carriage tape alignment frame 960, which can be preloaded with shape memory elements/actuators 950, 950′, 950″ for positioning. In step 4, the shape memory elements/actuators 950, 950′, 950″ can be embedded into the stenciled adhesive matrix 962′. In step 5, stenciled adhesive matrix 962′ can be cured, and the embedding pressure 966 removed. Other optional steps can be performed, for example, an insulating top-coat can be added, or the other side can be patterned by repeating steps 1-, the adhesive substrate (carriage tape) can be removed, e.g., with solvent; electrical traces can be wired or printed, for example, surface traces of conductive ink can be stenciled and cured; surface mount diodes can be located (e.g., using a stencil), placed, and cured; tension beams can be crimped; and the like.

While this invention has been particularly shown and described with references to preferred embodiments thereof, it will be understood by those skilled in the art that various changes in form and details may be made therein without departing from the scope of the invention encompassed by the appended claims.

1. An actuator array, wherein each actuator comprises:
a bistable mechanism; and
a first shape memory element mechanically coupled to the bistable mechanism that upon heating exerts a force that actuates the bistable mechanism from a first position to a second position.

2. The actuator array of claim 1, wherein the first shape memory element comprises a shape memory alloy, a bimetallic strip, or a thermally-actuated shape memory polymer.

3. The actuator array of claim 1, further comprising electrical leads coupled to the first shape memory element, whereby the first shape memory element is heated by application of electrical current.

4. The actuator array of claim 3, wherein the first shape memory element comprises at least two substantially parallel shape memory alloy wires electrically coupled in series to the electrical leads.

5. The actuator array of claim 1, further comprising a first heat source thermally coupled to the first shape memory element.

6. The actuator array of claim 5, further comprising a second heat source thermally coupled to a second shape memory element at each bistable mechanism that heats the second shape memory element to exert a force that actuates the bistable mechanism from the second position to the first position.

7. The actuator array of claim 6, wherein each shape memory element comprises a laminated array of substantially parallel shape memory alloy wires.

8. The actuator array of claim 7, wherein the wires comprise a shape memory alloy selected from the group consisting of NiTi, CuZnAl, and CuAlNi.

9. The actuator array of claim 8, wherein the wires are NiTi.

10. The actuator array of claim 8 wherein the shape memory wires have a diameter of less than about 500 micrometers.

11. The actuator array of claim 10 wherein the ratio of the diameter of the wires divided by the distance between adjacent wires is less than about 1.

12. The actuator array of claim 11 wherein each actuator operates in air at 25° C. at a frequency of at least about 2 cycles per second.

13. The actuator array of claim 5, wherein each bistable mechanism comprises a tension beam and a compression beam defined by a relief slit in a flexible substrate, and the first shape memory element actuates the compression beam from the first position to the second position.

14. The actuator array of claim 13, wherein the tension beam comprises a permanent out-of-plane deformation.

15. The actuator array of claim 13, wherein each shape memory element is coupled to the compression beam to convert the displacement of each shape memory element into a greater displacement at the compression beam.

16. The actuator array of claim 13, further comprising a second tension beam defined by a second relief slit, wherein the beams and the slits are substantially parallel.

17. The actuator array of claim 13, wherein the flexible substrate is in the form of a tape comprising the array of actuators as a linear array.

18. The actuator array of claim 13, wherein the flexible substrate is in the form of a sheet comprising the array of actuators as a two-dimensional array.

19. The actuator array of claim 13 wherein the flexible substrate comprises a material selected from the group consisting of steel alloy, phosphor bronze alloy, aluminum alloy, titanium alloy, carbon fiber/epoxy composite, fiberglass/epoxy composite, Kevlar/epoxy composite, polyimide, polyamide, polyester, polyvinylidene fluoride, polypropylene, polyethylene, and urethane.

20. The actuator array of claim 5, wherein the first shape memory element comprises a bimetallic layer.

21. The actuator array of claim 5, wherein the actuators are adapted for automatic control.

22. The actuator array of claim 21, further comprising one or more multiplexing diodes to independently control each actuator.

23. The actuator array of claim 22, further comprising an open loop automated controller coupled to the actuators.

24-70. (canceled)

71. A method of operating an actuator array, wherein each actuator comprises:
a bistable mechanism; and
a first shape memory element mechanically coupled to the bistable mechanism;
the method comprising the step of automatically, independently controlling each actuator by heating the first shape memory element to exert a force that actuates the bistable mechanism from a first position to a second position.

72. The method of claim 71, further comprising passing electrical current through the first shape memory element to heat each shape memory element.

73. The method of claim 71, further comprising heating the first shape memory element with a heat source coupled to each shape memory element.

74. The method of claim 71, further comprising heating a second heat source thermally coupled to a second shape memory element at each actuator to exert a force that actuates the bistable mechanism from the second position to the first position.

75. The method of claim 74, further comprising deactivating the heat sources after actuating each actuator.

76. The method of claim 74, wherein the first shape memory element is mechanically coupled to the compression beam, further comprising controlling the displacement of the first shape memory element to give a greater displacement at the compression beam.

77. The method of claim 74, wherein the first shape memory element comprises a laminated array of substantially parallel shape memory wires.

78. The method of claim 77, further comprising operating the actuators at a frequency at 25° C. in air of at least about 2 cycles per second.

79. The method of claim 74, wherein the first shape memory element comprises a bimetallic layer.

80-87. (canceled)
